(19) United States
(12) Patent Application Publication
(10) Pub. No.: US 2013/0103603 A1
(43) Pub. Date: Apr. 25, 2013

(54) SYSTEM AND METHOD FOR CHARITABLE FUNDRAISING

(71) Applicant: True Hero, LLC, Chagrin Falls, OH (US)

(72) Inventor: Michael Merriman, Chagrin Falls, OH (US)

(73) Assignee: TRUE HERO, LLC, Chagrin Falls, OH (US)

(21) Appl. No.: 13/654,922

(22) Filed: Oct. 18, 2012

Related U.S. Application Data
(60) Provisional application No. 61/549,938, filed on Oct. 21, 2011.

(51) Int. Cl. G06Q 99/00; G06Q 40/00; G06Q 30/02

(52) U.S. Cl. 705/329; 705/14.14; 705/34

(57) ABSTRACT

A system and method of making a charitable donation on a mobile device includes reading a code with the mobile device and requesting code related content in response to reading the code. The code related content is received from a server, the code related content comprising at least one short code associated with a charitable organization. In some embodiments, additional content may be provided to provide incentive to the user to make a donation. At least one of a SMS or MMS message is sent using the short code to make a donation to the charitable organization.

### RELATED APPLICATION DATA

This application claims the benefit of U.S. Provisional Patent Application No. 61/549,938, filed Oct. 21, 2011, the disclosure of which is incorporated herein by reference in its entirety.

### TECHNICAL FIELD

The technology of the present disclosure relates generally to charitable fundraising and, more particularly, to a system and method for making a charitable donation on a mobile device precipitated by reading a code.

### BACKGROUND

Mobile devices such as mobile telephones are now in wide-spread use, and the features associated with such mobile devices are becoming increasingly diverse. For example, many mobile telephones have cameras, text messaging capability, Internet browsing functionality, electronic mail capability, video playback capability, audio playback capability, and image display capability. Mobile telephones having such functionality are referred to commonly as “smartphones.”

Due much in part to their increased functionality, mobile devices have shown promise as a means for allowing a broad demographic of users to donate to a charitable organization or cause. But many conventional methods of charitable fundraising using a mobile device require affirmative steps by the user such as data entry and entering a credit card number. These steps may act as a deterrent to the user to making a donation because the steps are regarded as error prone, inconvenient, and/or insecure.

### SUMMARY OF THE INVENTION

The present disclosure provides a system and method for making a charitable donation on a mobile device to one or more charities. The principles of the present disclosure allow the user of a mobile device to make a charitable donation simply by reading a code (e.g., a barcode such as a Quick Response (“QR”) code, and/or a touchcode), receiving short codes for one or more charities, and sending a text message to a short code associated with a specified charitable organization or cause. From the perspective of the user of the mobile device, the steps associated with the donation process are conveniently consolidated on the mobile device, thereby minimizing the time and effort of the user. The entry of sensitive information by the user such as, for example, credit card information is also eliminated. In some embodiments, additional content, such as notification of the eligibility of donors to enter a raffle or contest, such as money saving coupon(s), such as links to online greeting card applications and/or media content, may be provided to the user of the mobile device during the donation process to provide incentive to the user to make a donation. Accordingly, the present disclosure provides a system and method that increases the likelihood that a user of a mobile device will make a charitable donation.

In accordance with one aspect of the disclosure, a method of making a charitable donation on a mobile device includes: reading a code with the mobile device, the code including at least one of a barcode (e.g. a QR code) or a touchcode; requesting code related content in response to reading the code; receiving the code related content from a server, the code related content comprising at least one short code associated with a charitable organization; and sending at least one of a SMS or MMS message using the short code to make a charitable donation to the charitable organization.

In one embodiment, the code related content is configured as at least one of a SMS message, a MMS message, or web content.

In another embodiment, the code related content comprises a plurality of short codes associated with respective charitable organizations. In another embodiment, the at least one of a SMS or MMS message is sent upon selection of a user-selectable short code associated with a charitable organization.

In another embodiment, the code is at least one of included with or incorporated into a product, product packaging, or store signage. In another embodiment, the product is merchandise related to at least one of the charitable organization, a parent organization, or a third-party organization.

In another embodiment, the code related content comprises at least one of multimedia content, or a coupon, or a hyperlink to multimedia content related to at least one of the charitable organizations, a parent organization, or a third-party organization, or a hyperlink to an online greeting card application.

In another embodiment, the code related content includes content informing a user of the mobile device that donors will be entered into a raffle for a chance to win a prize.

In accordance with another aspect of the disclosure, a method of processing a charitable donation from a mobile device includes: receiving at least one of a SMS or MMS message from the mobile device via a short code, the short code associated with a charitable organization identified in code related content provided to the mobile device in response to the mobile device reading a code including at least one of a barcode (e.g. a QR code) or a touchcode and requesting the code related content; and providing a donation amount associated with the short code to the charitable organization.

In one embodiment, the donation amount is provided by: requesting the donation amount from a server associated with the mobile device; receiving the donation amount from the server in response to the request; and providing the received donation amount to the charitable organization.

In another embodiment, the donation amount is provided to the charitable organization by a server associated with the mobile device.

In another embodiment, the method further includes billing the donation amount to a user of the mobile device.

In another embodiment, the method further includes: receiving the request for the code related content from the mobile device, the request resulting from the mobile device reading the code; and providing the code related content to the mobile device, the code related content comprising at least one short code associated with a charitable organization.

In another embodiment, the method further includes entering a user of the mobile device into a raffle for a chance to win a prize.

In another embodiment, the code related content is configured as at least one of a SMS message, a MMS message, or web content.

In another embodiment, the code related content comprises a plurality of short codes associated with various charitable organizations. In another embodiment, the at least one of a SMS or MMS message received from the mobile device is sent upon selection of a user-selectable content associated with a charitable organization.

In another embodiment, the code is at least one of included with or incorporated into a product, product packaging, or store signage.

In another embodiment, the code related content comprises at least one of multimedia content, or a coupon, or a hyperlink to multimedia content related to at least one of the charitable organization, a parent organization, or a third-party organization, or a hyperlink to an online greeting card application.

In accordance with another aspect of the disclosure, a mobile device configured to make a charitable donation, the mobile device includes: a code reading function configured to: read a code with the mobile device, the code including at least one of a barcode (e.g. a QR code) imaged by a camera of the mobile device or a touchcode read by a touchscreen of the mobile device; and request code related content in response to reading the code; and a messaging function configured to: receive code related content from a server, the code related content comprising at least one short code associated with a charitable organization; and send at least one of a SMS or MMS message using the short code to make a donation to the charitable organization.

The foregoing and other features of the disclosure are hereinafter described in greater detail with reference to the accompanying drawings.

### BRIEF DESCRIPTION OF THE DRAWINGS

FIG. 1 is a schematic view of an exemplary system for charitable fundraising;

FIG. 2 is a schematic block diagram of an exemplary mobile device illustrated in FIG. 1;

FIG. 3 is a flow diagram of an exemplary method of making a charitable donation on a mobile device;

FIG. 4 is a flow diagram of an exemplary method of providing code related content to the mobile device;

FIGS. 5-7 are exemplary embodiments of code related content displayed at the mobile device;

FIG. 8 is a flow diagram of an exemplary method of processing a charitable donation from the mobile device in accordance with the exemplary system of FIG. 1;

FIG. 9 is a flow diagram of another exemplary method of processing a charitable donation from the mobile device in accordance with the exemplary system of FIG. 1;

FIG. 10 is a schematic view of another exemplary system for charitable fundraising;

FIG. 11 is a flow diagram of an exemplary method of processing a charitable donation from the mobile device in accordance with the exemplary system of FIG. 10;

FIG. 12 is a schematic view of another exemplary system for charitable fundraising;

FIG. 13 is a flow diagram of an exemplary method of providing code related content to the mobile device and processing a charitable donation from the mobile device in accordance with the exemplary system of FIG. 12;

FIG. 14 is a schematic view of another exemplary system for charitable fundraising; and

FIG. 15 is a flow diagram of an exemplary method of providing code related content to the mobile device and processing a charitable donation from the mobile device in accordance with the exemplary system of FIG. 14.

### DESCRIPTION

In the description that follows, like components have been given the same reference numerals, regardless of whether they are shown in different embodiments. To illustrate an embodiment(s) of the present invention in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

The system for charitable fundraising described in the present disclosure provides a user of a mobile device with an opportunity for making a charitable donation on a mobile device. Upon reading a code with the mobile device, content is provided to the mobile device of the user pertaining to one or more charitable organizations or causes. With this information in mind, the user is offered an opportunity to select a charitable organization or cause and make a donation via text message. As further encouragement to make a donation, the user of the mobile device may be made aware that donors are entered into a raffle or contest, or the user may also be offered coupons from one or more sponsor organizations, as well as possible matching donations from such sponsor organization(s), or the user may be provided a link to an online greeting card application in order to notify the greeting card recipient that the donation has been made in their honor. In this way, the user is encouraged to make a donation with the prospects of contributing to social welfare, of winning a reward and of recognizing a third party with a greeting card in connection with the donation. Regardless of whether the user makes a charitable donation, the user is exposed to and made aware of the information of the charitable organization(s) or cause(s). Details of the system for charitable fundraising are described below in greater detail.

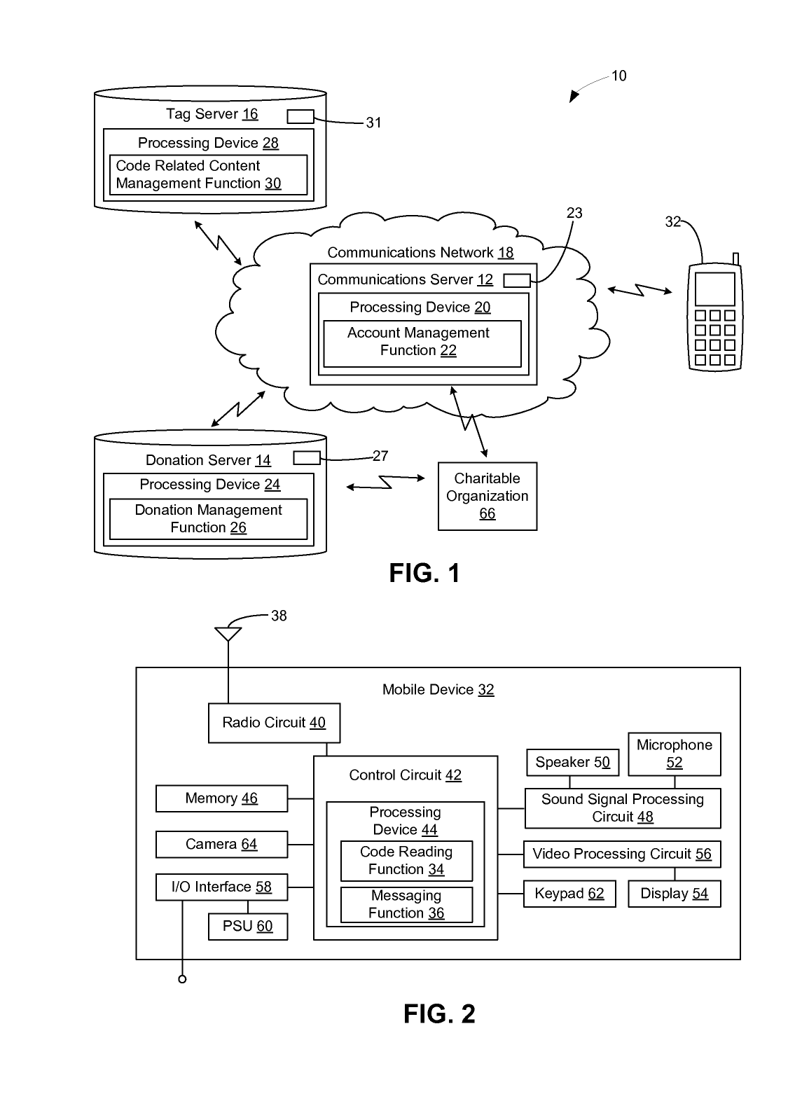

With reference to FIG. 1, an exemplary system for charitable fundraising is illustrated at 10. The system includes a communications server 12, donation server 14, and tag server 16. The communications server 12, donation server 14, and tag server 16 may be connected via communications network 18.

Communications server 12 may be included with the communications network 18 for managing calls placed by and destined to mobile devices, transmitting data to and receiving data from mobile devices, managing account information of mobile devices such as service plan information and device usage information, and carrying out any other support functions. The communications server 12 includes processing device 20 that is configured to execute an account management function 22 stored in a memory 23 of the communications server, the account management function 22 being configured to manage the account of a user of a mobile device on the network. For example, the account management function 22 may include computer software, program, code, logic and/or the like that may be stored in a non-transitory computer readable medium to carry out desired function(s). The account management function 22 may manage the billing of a user account based on the activity of a user of a mobile device. Billing includes the costs associated with the service plan of the mobile device, as well as those costs associated with actions performed using the mobile device that fall outside of the service plan. Such actions may include, for example, purchases, donations, and the like.

The system 10 also includes donation server 14 for managing donations made from mobile devices. Donation server 14 may be implemented as, for example, an Internet based server or a database server. The donation server 14 includes processing device 24 that is configured to execute a donation management function 26 stored in a memory 27 of the donation server, the donation management function 26 being configured to process and manage incoming text messages (e.g., short message service (SMS) and multimedia message service (MMS) messages) to short codes associated with the donations made from mobile devices. For example, the donation management function 26 may include computer software, program, code, logic and/or the like that may be stored in a non-transitory computer readable medium to carry out desired function(s). Short codes are telephone numbers, typically shorter than conventional seven-digit telephone numbers, which may be used to address SMS and MMS messages. A short code may be associated with a particular charitable organization or cause. For example, the donation management function 26 may associate a short code with the appropriate charitable organization or cause, as well as the appropriate donation amount to be made thereto. The donation management function 26 may also manage any incentive based programs that function to entice a user of a mobile device to make a donation (e.g., raffles in which donor are entered for a chance to win a prize, programs in which an organization will match a donation made by a user, etc.). The donation server 14 may further include a database (not shown) in which donation records may be recorded and stored.

The system 10 further includes tag server 16 for managing code related content provided to mobile devices. Tag server 16 may be implemented as, for example, an Internet based server or a database server. The tag server 16 includes processing device 28 that is configured to execute a code related content management function 30 stored in a memory 31 of the tag server, code related content management function 30 being configured to process requests for code related content from mobile devices and send code related content in response to the request received. For example, the code related content management function 30 may include computer software, program, code, logic and/or the like that may be stored in a non-transitory computer readable medium to carry out desired function(s). The tag server 16 may further include a database (not shown) in which code related content may be recorded and stored. The code related content stored in the database is retrievable by the code related content management function 30, and may be provided to a mobile device in response to a request for code related content. The code related content may be updated or replaced (e.g., by an administrator) in order to keep the code related content up to date with the latest information, promotions, etc.

The communications server 12, donation server 14, and/or tag server 16 may be respectively configured as typical computer systems used to carry out several functions and the respective processors 20, 24, 28 may be configured to execute software containing logical instructions that embody the functions of the server and a memory to store such software. Accordingly, in one embodiment, the account management function 22, donation management function 26, and code related content management function 30 are respectively embodied as one or more computer programs (e.g., one or more software applications including compilations of executable code). The computer program(s) may be stored on a non-transitory machine (e.g., computer) readable medium, such as a memory in the form of a magnetic, optical or electronic storage device (e.g., hard disk, optical disk, flash memory, etc.). In accordance with the embodiments of the present application, the account management function 22, donation management function 26, and/or code related content management function 30 may be stored in one or more of the memories 23, 27, 31, collectively or separately.

A mobile device 32 (e.g., a “smartphone”) may be in communication with the system 10. The mobile device 32 may include a code reading function 34 for reading a code (e.g., a barcode such as a QR code, and/or a touchcode) with the mobile device and requesting code related content in response to reading the code; and messaging function 36 for receiving the code related content from a server and sending at least one of a SMS or MMS message using a short code. The code reading function 34 and the messaging function 36 interact with the code related content management function 30 of tag server 16 and the donation management function 26 of the donation server 14, respectively. Details of the code reading function 34 and messaging function 36 will be described below in greater detail.

The mobile device 32 may communicate with the communications server 12, donation server 14, and/or tag server 16 via a transmission medium. The transmission medium may be any appropriate device or assembly, including, for example, a communications base station (e.g., a cellular service tower, or “cell” tower), a wireless access point, a satellite, etc. The communications network 18 may support the communications activity of multiple mobile devices 32 and other types of end user devices.

The mobile device 32 includes communications circuitry that enables the mobile device 32 to establish communications with the system 10. Communications may include data transfers and the like. Data transfers may include, but are not limited to, receiving streaming content (e.g., streaming audio, streaming video, etc.), receiving data feeds (e.g., pushed data, podcasts, really simple syndication (RSS) data feeds), downloading and/or uploading data (e.g., image files, video files, audio files, ring tones, Internet content, etc.), receiving or sending messages (e.g., text messages, instant messages, electronic mail messages, multimedia messages), receiving and placing telephone calls, and so forth. This data may be processed by the mobile device 32, including executing applications to allow user interaction with the data, displaying video and/or image content associated with the data, outputting audio sounds associated with the data, and so forth.

FIG. 2 is a schematic block diagram of an exemplary mobile device 32 illustrated in FIG. 1. In the exemplary embodiment, the communications circuitry may include an antenna 38 coupled to a radio circuit 40. The radio circuit 40 includes a radio frequency transmitter and receiver for transmitting and receiving signals via the antenna 38. With continuing reference to FIG. 1, the radio circuit 40 may be configured to operate in the mobile communications network 18. Radio circuit 40 types for interaction with the mobile communications network 18 include, but are not limited to, global system for mobile communications (GSM), code division multiple access (CDMA), wideband CDMA (WCDMA), general packet radio service (GPRS), long term evolution (LTE), WiFi, WiMAX, digital video broadcasting-handheld (DVB-H), integrated services digital broadcasting (ISDB), high speed packet access (HSPA), etc., as well as advanced versions of these standards or any other appropriate standard. It will be appreciated that the mobile device 32 may be capable of communicating using more than one standard. Therefore, the antenna 38 and the radio circuit 40 may represent one or more than one radio transceiver.

The mobile device 32 may include a primary control circuit 42 that is configured to carry out overall control of the functions and operations of the mobile device 32. The control circuit 42 may include a processing device 44, such as a central processing unit (CPU), microcontroller or microprocessor. The processing device 44 executes code stored in a memory (not shown) within the control circuit 42 and/or in a separate memory, such as the memory 46, in order to carry out operation of the mobile device 32.

For instance, the memory within the control circuit 42 and/or the memory 46 may store executable code that embodies the code reading function 34 and messaging function 36, and the processing device 44 may execute that code so that the control circuit 42 is configured to implement the functions of the code reading function 34 and messaging function 36. The memory 46 may be, for example, one or more of a buffer, a flash memory, a hard drive, a removable media, a volatile memory, a non-volatile memory, a random access memory (RAM), or other suitable device. In a typical arrangement, the memory 46 may include a non-volatile memory for long term data storage and a volatile memory that functions as system memory for the control circuit 42. The memory 46 may exchange data with the control circuit 42 over a data bus. Accompanying control lines and an address bus between the memory 46 and the control circuit 42 also may be present.

The mobile device 32 further includes a sound signal processing circuit 48 for processing audio signals transmitted by and received from the radio circuit 40. Coupled to the sound signal processing circuit 48 are a speaker 50 and a microphone 52 that enable a user to listen and speak via the mobile device 32. The radio circuit 40 and sound signal processing circuit 48 are each coupled to the control circuit 42 so as to carry out overall operation. Audio data may be passed from the control circuit 42 to the sound signal processing circuit 48 for playback to the user. The audio data may include, for example, received audio data in the form of voice communications or streaming audio data from the code related content management function 30. The sound signal processing circuit 48 may include any appropriate buffers, decoders, encoders, amplifiers and so forth.

The display 54 may be coupled to the control circuit 42 by a video processing circuit 56 that converts video data to a video signal used to drive the display 54. The video processing circuit 56 may include any appropriate buffers, decoders, video data processors and so forth. The video data may be generated by the control circuit 42, derived from an incoming video data stream that is received by the radio circuit 40 (e.g., from the code related content management function 30) or obtained by any other suitable method.

The mobile device 32 may further include one or more input/output (I/O) interface(s) 58. The I/O interface(s) 58 may be in the form of typical mobile telephone I/O interfaces and may include one or more electrical connectors. Operating power may be received over the I/O interface(s) 58 and power to charge a battery of a power supply unit (PSU) 60 within the mobile device 32 may be received over the I/O interface(s) 58. The PSU 60 may supply power to operate the mobile device 32 in the absence of an external power source.

A keypad 62 provides for a variety of user input operations. For example, the keypad 62 may include alphanumeric keys for allowing entry of alphanumeric information (e.g., telephone numbers, phone lists, contact information, notes, text, etc.), special function keys (e.g., a call send and answer key, multimedia playback control keys, a camera shutter button, etc.), navigation and select keys or a pointing device, and so forth. Keys or key-like functionality also may be embodied as a touch screen associated with the display 54. Also, the display 54 and keypad 62 may be used in conjunction with one another to implement soft key functionality. In embodiments where the mobile device 32 includes a touch screen associated with the display 54, the touch screen may be used to read a touchcode for use in connection with the code reading function 34. An exemplary source of the touchcode technology is Printechnologics GmbH, Zwickauer Stra [symbol] e 56, 09112 Chemnitz, Germany.

The mobile device 32 also may include a camera 64 for taking digital pictures and/or movies. Image and/or video files corresponding to the pictures and/or movies may be stored in the memory 46. Images captured using camera 64 such as an image of a barcode may be used, for example, in connection with the code reading function 34.

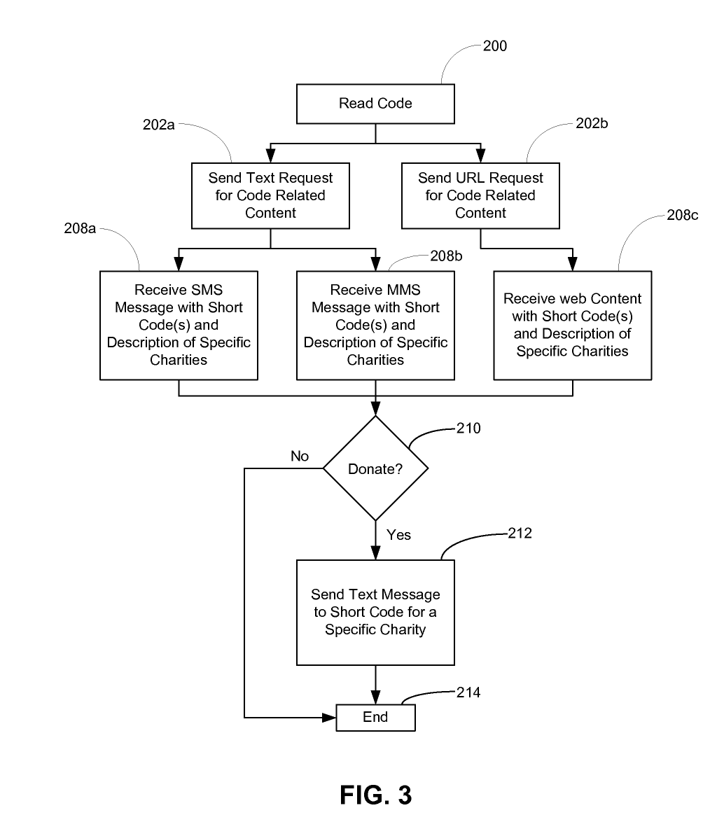

FIG. 3 is a flow diagram of an exemplary method of making a charitable donation on a mobile device 32. At block 200, the mobile device reads the code associated with the system for charitable fundraising. In some embodiments, the mobile device 32 reads a barcode (e.g., QR code). More specifically, the camera 64 of the mobile device 32 may image the barcode, and the code reading function 34 may process the barcode image to obtain information therefrom. In other embodiments, the mobile device 32 reads a touchcode. More specifically, an article including a capacitive code is brought into close proximity or into contact with the touch screen associated with the display to read the touchcode, and the code reading function 34 may process the information read.

Information obtained from the code may include, for example, an address of the tag server 16 to which a request for code related content may be sent, identification of the type of code related content requested, and the like. The code reading function 34 may be embodied as an application stored on the mobile device 32. Such application may be downloaded to the mobile device 32 (e.g., from the tag server 16 or other source) in order to provide the code reading functionality.

The code may be provided in any suitable manner. In one example, the code is provided as a part of an advertisement or promotional material such as, for example, on a leaflet, pamphlet, billboard, button, embroidered patch, poster, retail shelf sign, product packaging, or similar form. In some embodiments, advertisement or promotional material may include electronic forms of display (e.g., a digital image) or any other form that may be imaged by the camera 64 of the mobile device 32. Advertisement or promotional material may be associated with an organization and/or event. In one embodiment, the advertisement or promotional material may include information pertaining to a charitable organization to which a donation may be made. In other embodiments, the advertisement or promotional material may include information pertaining to the organization (e.g., a parent organization or third-party organization) that is sponsoring the charitable fundraising effort. Other types of advertisement or promotional material may be used.

The barcode may also be provided with or as a part of merchandise, for example, an article of clothing, souvenir, or other similar item. The code may be included with the sales tag, product packaging, or may be incorporated into the article itself. In one example, a code is integrated with sports apparel associated with an organization (e.g., a school or professional sports franchise) with, for example, a button, patch, or printed code pattern attached to a jersey, hat, shoe, jacket, etc. A code may be included with the sales tag of the apparel, or may be integrated with the apparel itself (e.g., on the label or sleeve of a jersey). The code may be read either prior or subsequent to purchase of the apparel.

After processing the code, the code reading function 34 (FIG. 1) sends a request for code related content to the tag server 16. The form in which the code related content is requested may vary. As illustrated at block 202a, the request may be sent via text message (e.g., SMS or MMS). As illustrated at block 202b, the request may be sent via URL request. With continued reference to FIG. 1, the code related content management function 30 of the tag server 16 is configured to process the request for code related content from the mobile device 32 and the provide code related content.

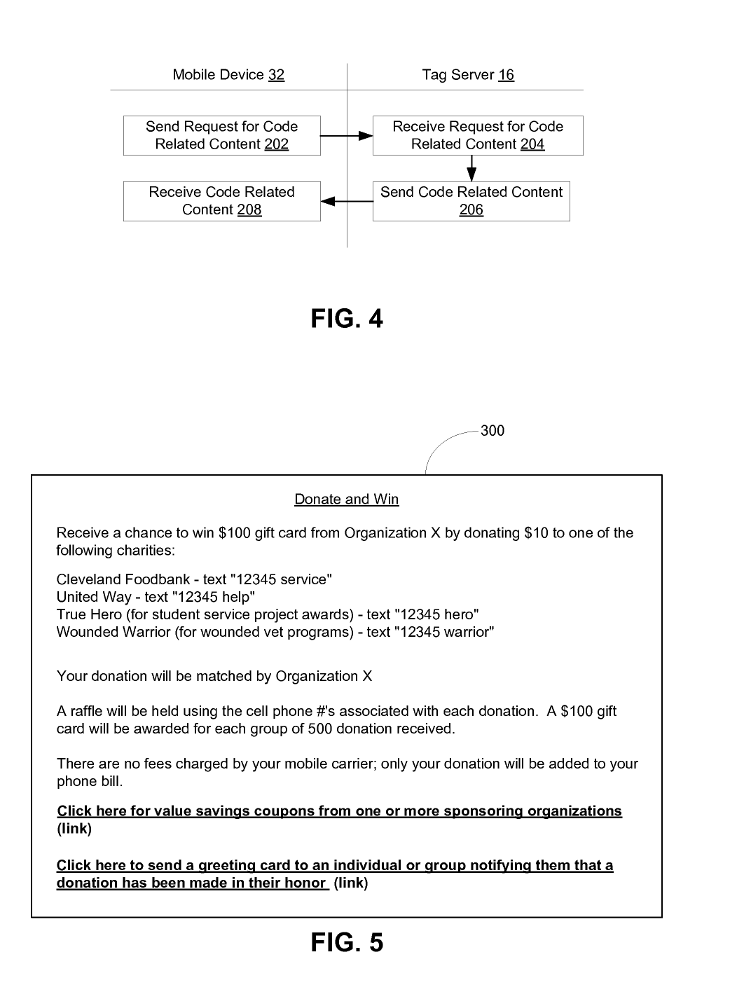

FIG. 4 is a flow diagram illustrating the request for code related content. As discussed above, the mobile device 32 sends the request for code related content to the tag server 16 at block 202. The request may include information associated with the code read by the mobile device and processed by the code reading function 34 (FIG. 1). At block 204, the request for code related content is received at the tag server 16. The request is processed by the code related content management function 30, and at block 206, code related content is sent from the tag server 16 to the mobile device 32. At block 208, the code related content is received at the mobile device 32 (e.g., by the messaging function 36).

With continuing reference to FIG. 3, the form in which the code related content is received at the mobile device 32 may be dependent on the request sent by the mobile device 32. For example, when the request is sent via text message (e.g., SMS or MMS) (block 202a), the received code related content may be a SMS message (block 208a) or a MMS message (block 108b). When the request is sent via URL request (202b), the received code related content may be web content associated with the URL (block 208c).

Regardless of the form in which the code related content is received, the code related content includes at least one short code. Each short code is associated with a specific charitable organization or cause. The code related content may also include content associated with the organization such as, for example, a description of the organization. In embodiments where the charitable fundraising effort is sponsored and/or organized by a parent or third-party organization, the code related content may include a description of the parent or third-party organization. Other content that may be included with the code related content includes multimedia content or hyperlinks to multimedia content (e.g., audio, video) associated with the charitable organization(s), cause, parent organization, and/or third-party organization(s), including one or more coupons. Information may also be included that informs a user of the mobile device that donors will be entered into a raffle (drawing, contest, etc.) for a chance to win a prize (e.g., a gift card, event tickets, etc.), and/or that donations may be matched (e.g., by the parent organization or third-party organization). Such information may provide incentive to the user of the mobile device to make a donation.

FIGS. 5-7 are exemplary embodiments of code related content displayed at the display 54 of the mobile device 32. As such, FIGS. 5-7 may be exemplary user interfaces at the display of the mobile device in which the user may interact with the code related content and effectuate a donation.

FIG. 5 illustrates an exemplary embodiment wherein a third-party organization (e.g., Organization X) has sponsored and/or organized a charitable fundraiser for multiple charitable organizations (e.g., Cleveland Foodbank, United Way, True Hero, and Wounded Warrior). The code related content 300 includes a plurality of short codes, each short code associated with a specific charitable organization. The code related content 300 also includes a description that donors have a chance to win a prize (e.g., a gift card) from sponsoring Organization X, and that a donation by the user will be matched by Organization X. Furthermore, the code related content 300 includes an explanation of how the user will be billed for the donation. In addition, the code related content includes a hyperlink to one or more coupons from one or more sponsoring organizations. Such coupons may include one or more coupons from a sponsoring organization and/or another organization. The code related content also includes a hyperlink to an online greeting card application in order for the donor to honor the greeting card recipient (e.g., by notifying a recipient of the greeting card such as an individual or group that a donation has been made in their honor).

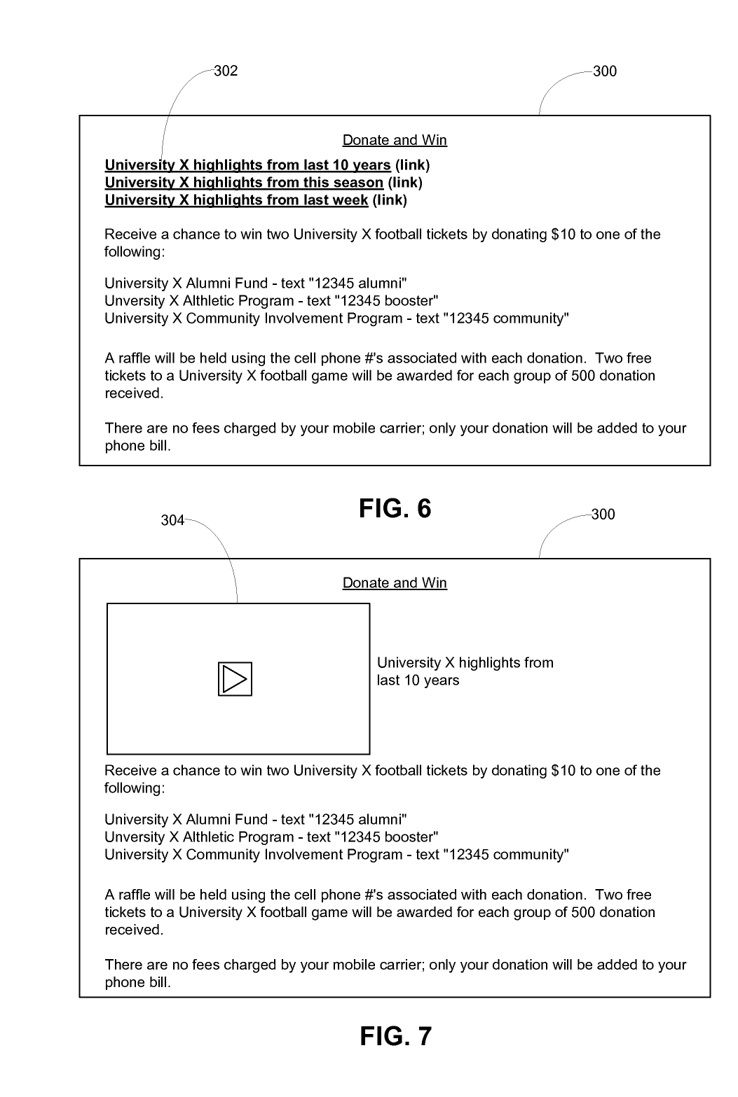

FIGS. 6 and 7 illustrate exemplary embodiments wherein a parent organization (e.g., University X) has sponsored and/or organized a charitable fundraiser for multiple charitable funds of the organization (e.g., University X Alumni Fund, University X Athletic Program, and University X Community Involvement Program). The code related content 300 includes a plurality of short codes, each short code associated with a specific charitable fund of the organization. The code related content 300 also includes a description that donors have a chance to win a prize (e.g., two University X football tickets) from University X. Furthermore, the code related content includes an explanation of how the user will be billed for the donation. The code related content 300 embodied in FIGS. 6 and 7 additionally include multimedia associated with University X (e.g., University X highlights). Specifically, the code related content 300 of FIG. 6 includes hyperlinks 302 to such multimedia content. Upon selecting one of the hyperlinks 302, the mobile device 32 may request and receive the associated multimedia content (e.g., from the tag server 16, from a URL address, etc). The code related content 300 of FIG. 7 includes multimedia content 304. Upon selecting the multimedia content 304, the multimedia content may be played (e.g., by playing a filed included with the code related content or by streaming the content). In another embodiment, the multimedia content 304 may be played automatically upon receiving and viewing the code related content 300.

The multimedia content may serve as a stimulus for making a donation. For example, watching highlights of University X's athletic programs may entice a user of the mobile device 32 to donate to the University X Athletic Program. In addition, the multimedia content may serve as a stimulus for building loyalty to University X. In the examples provided in FIGS. 6 and 7, the multimedia content of University X highlights may provide the user of the mobile device 32 with a sense of pride or excitement relating to University X.

Outside of the University context, the multimedia content provided with the code related content may serve as a stimulus for building loyalty to a company or other organization. In one example, a company (e.g., Company X) may organize and/or sponsor a charitable fundraiser for an organization (e.g., Harvest for Hunger). Promotional materials including the code may be displayed at stores owned by Company X. The code related content associated with the code may include multimedia content relating to Company X's involvement with Harvest for Hunger. As a result, the multimedia content may entice a user of the mobile device to donate to the organization. The multimedia content may also build loyalty to Company X (e.g., due to Company X's community involvement).

In another example, a professional sports organization (e.g., Organization X) may organize and/or sponsor a charitable fundraiser for an organization (e.g., Habitat for Humanity). Codes (e.g., barcodes and/or touchcodes) may be included on apparel (e.g., jerseys, hats, shirts, shoes, etc. via buttons, embroidered patches, tags, printed patterns, and the like) associated with Organization X. The code related content associated with the code may include multimedia content relating to Organization X's involvement with Habitat for Humanity (e.g., highlights of professional athletes building homes). That is, the multimedia content is not content related to the apparel itself, but rather is content relating to Organization X. The multimedia content provided with the code related content does not necessarily entice a user of the mobile device to purchase apparel including the code. Instead, the multimedia content may entice a user of the mobile device to donate to the charity sponsored by Organization X. The multimedia content may also build loyalty and/or support for Organization X (e.g., due to Organization X's community involvement).

With continued reference to FIG. 3, a user of the mobile device 32 may or may not elect to make a donation (block 210). If a donation is not made, the process ends at block 214. If a donation is made, a text message (SMS or MMS message) is sent from the mobile device 32 to the short code at block 212. The text message may be sent using the messaging function 36 of the mobile device 32. The short code(s) displayed with the code related content (e.g., as shown in FIGS. 5-7) may be selectable by a user of the mobile device 32 such that selecting a short code for a specific charity results in sending a text message to the donation server 14 via the short code by the messaging function 36. Accordingly, in one embodiment, sending of a text message to a short code may be effectuated by selecting one of the short codes displayed with the code related content (e.g., in FIGS. 5-7). In another embodiment, the text message and associated short code may be entered manually by the user and sent by messaging function 36. The process ends at block 214.

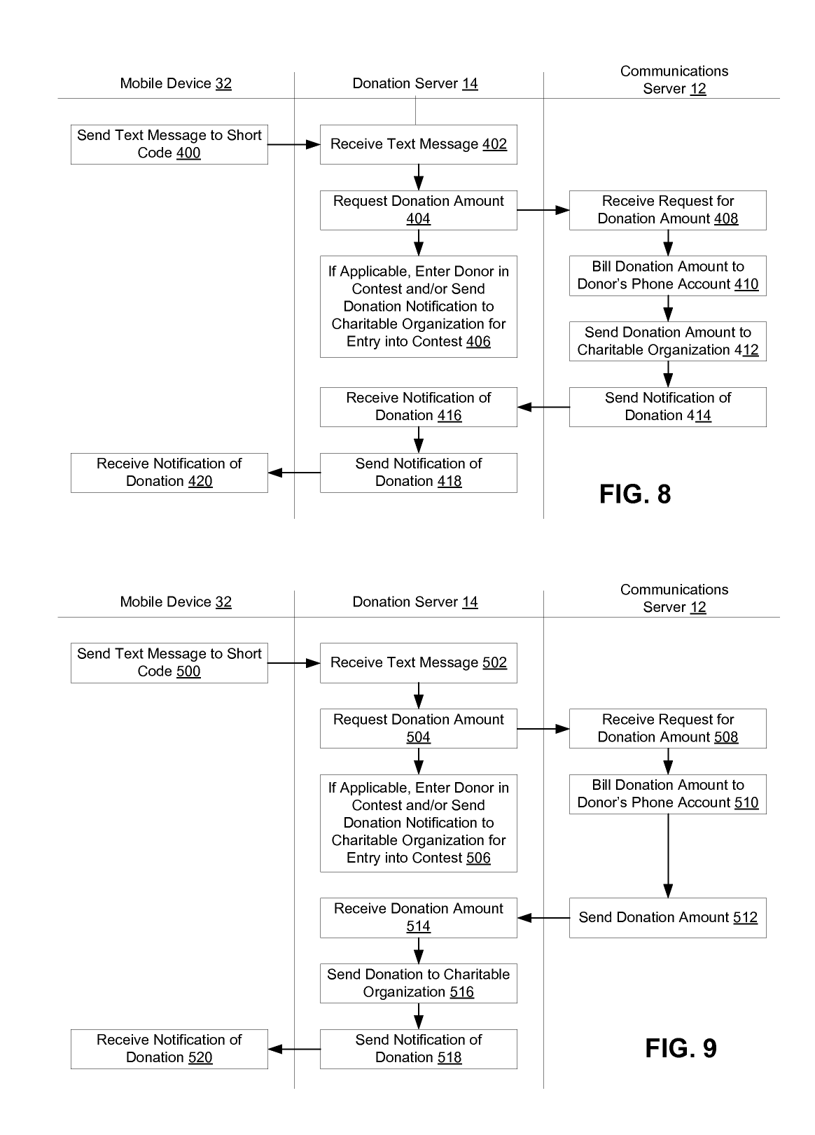

FIG. 8 is a flow diagram of an exemplary method of processing a charitable donation from a mobile device in accordance with the system 10 of FIG. 1. At block 400, a text message is sent using the messaging function 36 from the mobile device 32 to the donation server 14 (via the short code), and the text message is received by the donation server 14 at block 402. A request for the donation amount is sent by the donation server 14 to the communications server 12 at block 404, and the request for the donation amount is received by the communications server 12 at block 408. The request for the donation amount sent by the donation server 14 may include information for instructing the communications server 12 how to distribute the donation (e.g., an address for sending the donation). If the code related content included content informing the user of the mobile device 32 that donors will be entered into a raffle, then the user of the mobile device 32 is entered into the raffle at block 406. Alternatively or additionally, the donation server 14 may notify the charitable organization 66 of the donation so that the charitable organization enters the donor into the raffle at block 406. In either case, information such as the phone number of the donor may be used in entering the donor into the raffle.

The donation amount is billed to the user of the mobile device 32 (donor) at block 410. In one embodiment, the donation amount is added to the user's monthly statement associated with the user's phone account. In another embodiment, the donation amount is billed as a separate invoice to the user of the mobile device. At block 412, the donation amount is sent to the charitable organization 66 in accordance with the instructions provided by the donation server 14. At block 414, a notification of the donation is sent from the communications server 12 and is received by the donation server 14 at block 416. At block 418, the notification of the donation is sent from the donation server 32 and received by the mobile device 32 at block 420. The notification sent from the donation server 14 to the mobile device 32 may include a thank you message and/or additional multimedia content in order to show appreciation to the user for the donation.

Furthermore, if the code related content included content informing the user that a parent or third-party organization would match the donated amount, then the donation server 14 (via the donation management function 26) may request the matching amount from the parent or third-party organization. In other embodiments, the donation server 14 forwards a notification of the donated amount to the charitable organization 66, and the matching donation request is made by the charitable organization 66 to the parent or third-party sponsoring organization.

In another embodiment, the donation amount may be sent from the communications server 12 (via the account management function 22) to the donation server 14, and the donation server 14 (via the donation management function 26) may manage the funds donated by mobile devices. The donation management function 26 of the donation server 14 may allocate the received funds accordingly.

For example, FIG. 9 is a flow diagram of another exemplary method of processing a charitable donation from a mobile device 32 in accordance with the system 10 of FIG. 1. Similar to the embodiment of FIG. 8, a text message is sent from the mobile device 32 to the short code (block 500) and received by the donation server 14 (block 502). A request for the donation amount is sent by the donation server 14 to the communications server 12 (block 504), and the request for the donation amount is received by the communications server 12 (block 508). The user of the mobile device 32 may be entered into the raffle via the donation server 14 and/or the charitable organization 66 (block 506), and the donation amount is billed to the user of the mobile device 32 (block 510). But in the embodiment illustrated in FIG. 9, the donation amount is sent from the communications server 12 (block 512) and received at the donation server 14 (block 514). The donation server 14 sends the donation to the charitable organization 66 (block 516) and sends a notification of the donation (block 518). The notification is received by the mobile device 32 at block 520. Hence, in the embodiment of FIG. 9, it is the donation server 14 that manages and distributes the donations to the respective charitable organizations 66, and the communications server 12 simply charges the user of the mobile device 32 for the donation.

A percentage of the donation amount may be apportioned to one or more third parties (e.g., to enable implementation of the system 10). For example, a percentage of the donation amount may be applied to fees associated with operation of the communication server 12, donation server 14, and/or tag server 16. Other amounts may be apportioned to an organization that oversees the operation of the system, or used to purchase a contest prize. In an exemplary embodiment, about 20% of the gross donation may be apportioned to one or more third parties. This percentage may vary depending on operating costs, the monetary value of contest prizes awarded, and any matching contributions from retailers.

In the embodiments that follow, systems for charitable fundraising are described that possess similar functionalities to those which are described above. Accordingly, some of the features of the embodiments discussed below may not be described fully. But it is to be understood that features that are described and/or illustrated with respect to the foregoing embodiment may be used in the same way or in a similar way in one or more following embodiments.

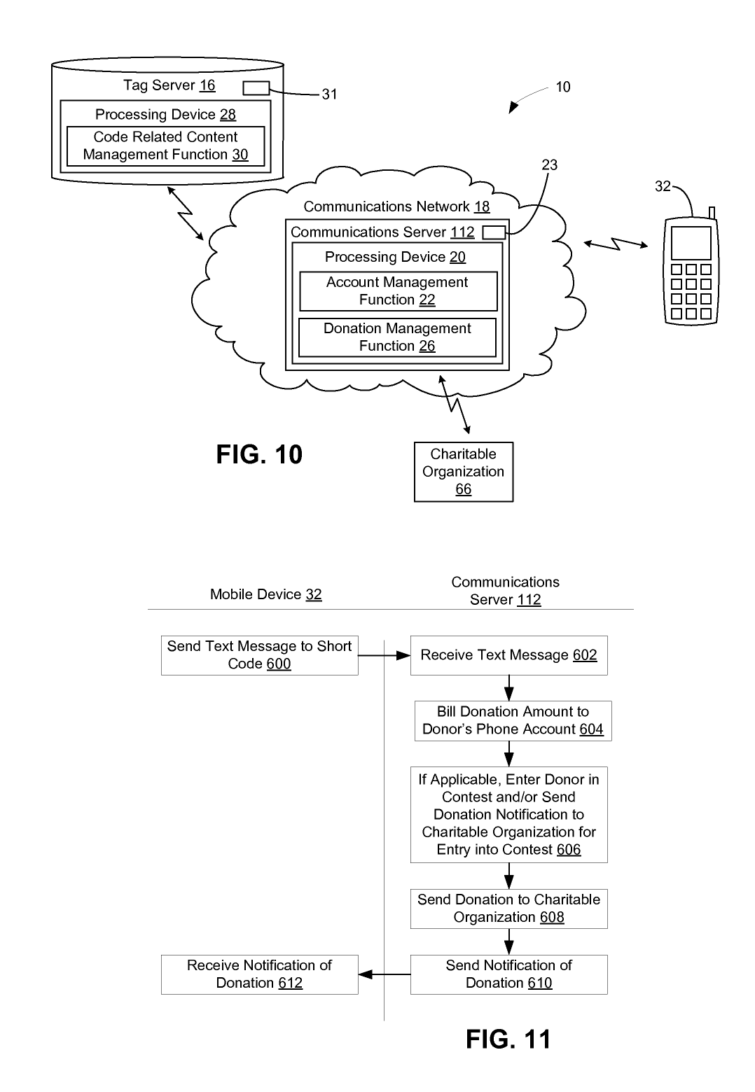

FIG. 10 is a schematic view of another exemplary system 10 for charitable fundraising. In the embodiment of FIG. 10, the functionality of the donation server is integrated with the communications server. That is, communications server 112 includes both the account management function 22 and donation management function 26, both functions being executed by processing device 20. In the embodiment of FIG. 10, both the account management function 22 and donation management function 26 may be stored by the memory 23. As such, the request for code related content is still performed between the mobile device 32 and tag server 16 (e.g., as illustrated in FIG. 4). But the text message sent from the mobile device 32 via the short code is instead provided to the communications server 112.

FIG. 11 is a flow diagram of another exemplary method of processing a charitable donation from a mobile device 32 in accordance with the exemplary system of FIG. 10. At block 600, a text message is sent from the mobile device 32 to the communications server 112 (via the short code). The text message is received by the communications server 112 at block 602 and the donation amount is billed to the user of the mobile device 32 at block 604. If the code related content included content informing the user of the mobile device that donors will be entered into a raffle for a chance to win a prize, then the user of the mobile device 32 is entered into the raffle via the communication server 112 and/or the charitable organization 66 at block 606. At block 608, the donation amount is sent by the communications server 112 to the organization 66 to which the donation amount is to be directed. The communications server 112 sends a notification of the donation to the mobile device 32 (block 610), and the notification is received by the mobile device 32 (block 612).

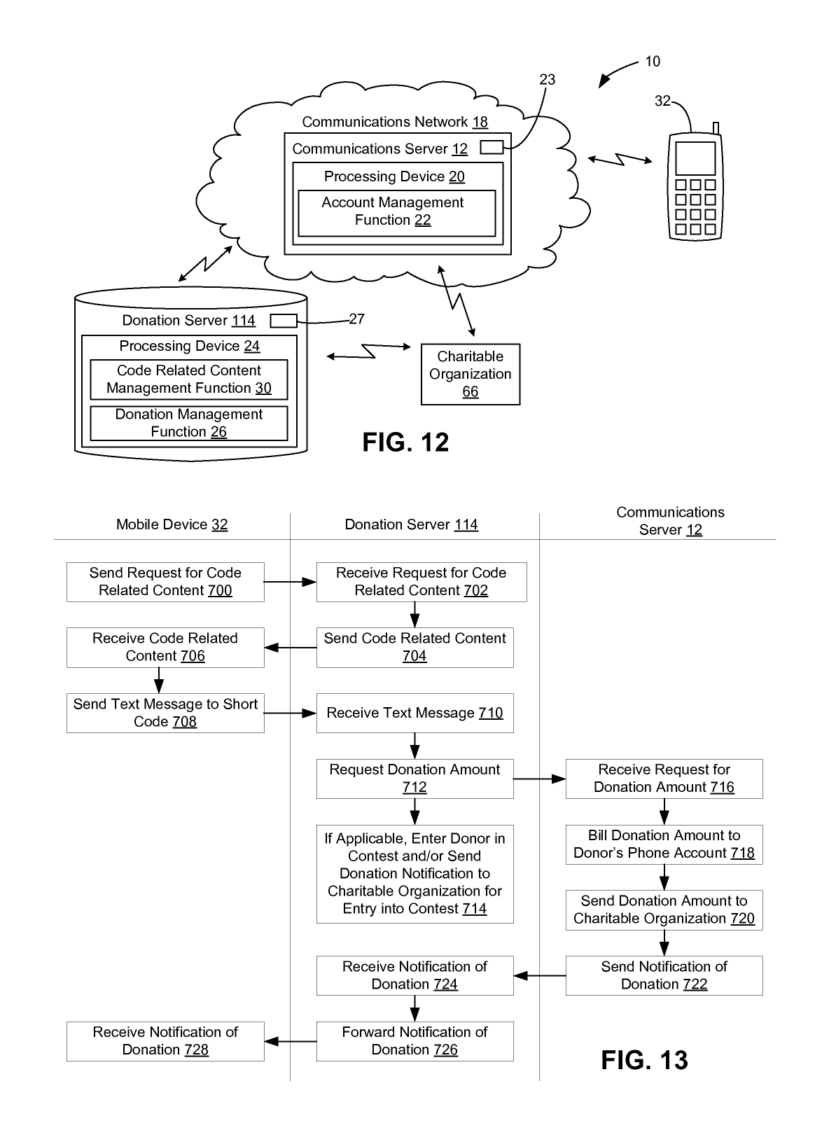

The above embodiments describe the tag server 16 as being separate from the donation server and communications server. But as illustrated in FIG. 12, the functionality of the tag server may be integrated with the donation server. FIG. 12 is a schematic view of another exemplary system 10 for charitable fundraising in which the donation server 114 includes both the code related content management function 30 and donation management function 26, both functions being executed by processing device 24. In the embodiment of FIG. 12, both the code related content management function 30 and donation management function 26 may be stored by the memory 27. As described below, the request for code related content is performed between the mobile device 32 and donation server 114.

FIG. 13 is a flow diagram of another exemplary method of providing code related content to the mobile device and processing a charitable donation from a mobile device in accordance with the exemplary system of FIG. 12. The mobile device 32 sends the request for code related content to the donation server 114 at block 700. At block 702, the request for code related content is received at the donation server 114. The request is processed by the code related content management function 30, and at block 704, code related content is sent from the donation server 114 to the mobile device 32. At block 706, the code related content is received at the mobile device 32.

If a donation is not made at the mobile device 32, a text message is not sent from the mobile device 32 and the process ends at block 706. If a donation is made at the mobile device 12, a text message is sent from the mobile device 32 to the donation server 114 (via the short code) at block 708. The text message is received by the donation server 114 at block 710. A request for the donation amount is sent by the donation server 114 to the communications server 12 at block 712 and the request for the donation amount is received by the communications server 12 at block 716. If the code related content included content informing the user of the mobile device that donors will be entered into a raffle for a chance to win a prize, then the user of the mobile device 32 is entered into the raffle via the donation server 114 and/or the charitable organization 66 at block 714. The donation amount is billed to the user of the mobile device 32 at block 718. At block 720, the donation amount is sent to the organization 66. At block 722, a notification of the donation is sent from the communications server 12 and is received by the donation server 114 at block 724. At block 726, the notification of the donation is sent from the donation server 114 and received by the mobile device 32 at block 728.

The embodiment of FIG. 13 illustrates processing the charitable donation from the mobile device (e.g., blocks 708-728) in a manner similar to that illustrated in FIG. 8. In another illustrative embodiment, such processing may instead proceed in a manner similar to that illustrated in FIG. 9.

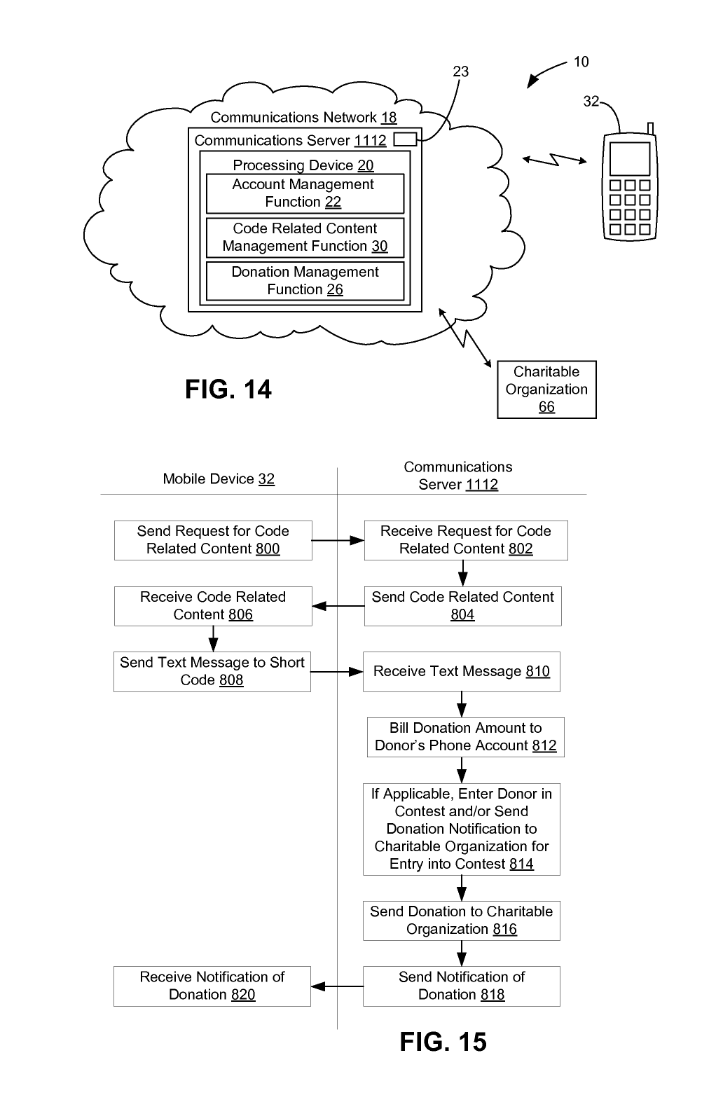

In other embodiments of the system for charitable fundraising, the functionalities of the tag server, donation server, and communications server are integrated into a single server. For example, FIG. 14 is a schematic view of a system 10 for charitable fundraising in which the communications server 1112 includes the account management function 22, code related content management function 30, and donation management function 26, such functions being executed by processing device 20. In the embodiment of FIG. 14, the account management function 22, code related content management function 30, and donation management function 26 may be stored by the memory 23. As a result, the request for code related content and processing of the charitable donation is performed between the mobile device 32 and the communications server 1112.

FIG. 15 is a flow diagram of another exemplary method of providing code related content to the mobile device and processing a charitable donation from a mobile device in accordance with the exemplary system of FIG. 14. The mobile device 32 sends the request for code related content at block 800. At block 802, the request for code related content is received at the communications server 1112. The request is processed by the code related content management function 30, and at block 804, code related content is sent from the communications server 1112 to the mobile device 32. At block 806, the code related content is received at the mobile device 32.

If a donation is not made at the mobile device 32, a text message is not sent from the mobile device 32 and the process ends at block 806. If a donation is made at the mobile device 32, a text message is sent from the mobile device 32 to the communications server 1112 (via the short code) at block 808. The text message is received by the communications server 1112 at block 810 and the donation amount is billed to the user of the mobile device 32 at block 812. If the code related content included content informing the user of the mobile device that donors will be entered into a raffle for a chance to win a prize, then the user of the mobile device 32 is entered into the raffle via the communications server 1112 and/or the charitable organization 66 at block 814. At block 816, the donation amount is sent by the communications server 1112 to the charitable organization 66 to which the donation amount is to be directed. The communications server 1112 sends a notification of the donation at block 818, and the notification is received by the mobile device 32 at block 820.

Although particular embodiments of the invention have been described in detail, it is understood that the invention is not limited correspondingly in scope, but includes all changes, modifications, and equivalents coming within the spirit and terms of the claims appended hereto.

What is claimed is:

1. A method of making a charitable donation on a mobile device, comprising:
reading a code with the mobile device, the code comprising at least one of a barcode or a touchcode;
requesting code related content in response to reading the code;
receiving the code related content from a server, the code related content comprising at least one short code associated with a charitable organization; and
sending at least one of a SMS or MMS message using the short code to make a charitable donation to the charitable organization.

2. The method of claim 1, wherein the code related content is configured as at least one of a SMS message, a MMS message, or web content.

3. The method of claim 1, wherein the code related content comprises a plurality of short codes associated with respective charitable organizations.

4. The method of claim 3, wherein the at least one of a SMS or MMS message is sent upon selection of a user-selectable short code associated with a charitable organization.

5. The method of claim 1, wherein the code is at least one of included with or incorporated into a product, product packaging, or store signage.

6. The method of claim 5, wherein the product is merchandise related to at least one of the charitable organization, a parent organization, or a third-party organization.

7. The method of claim 1, wherein the code related content comprises at least one of multimedia content, or a coupon, or a hyperlink to multimedia content related to at least one of the charitable organizations, a parent organization, or a third-party organization, or a hyperlink to an online greeting card application.

8. The method of claim 1, wherein the code related content includes content informing a user of the mobile device that donors will be entered into a raffle for a chance to win a prize.

9. A method of processing a charitable donation from a mobile device, comprising:
receiving at least one of a SMS or MMS message from the mobile device via a short code, the short code associated with a charitable organization identified in code related content provided to the mobile device in response to the mobile device reading a code comprising at least one of a barcode or a touchcode and requesting the code related content; and
providing a donation amount associated with the short code to the charitable organization.

10. The method of claim 9, wherein the donation amount is provided by:
requesting the donation amount from a server associated with the mobile device;
receiving the donation amount from the server in response to the request; and
providing the received donation amount to the charitable organization.

11. The method of claim 9, wherein the donation amount is provided to the charitable organization by a server associated with the mobile device.

12. The method of claim 9, further comprising billing the donation amount to a user of the mobile device.

13. The method of claim 9, further comprising:
receiving the request for the code related content from the mobile device, the request resulting from the mobile device reading the code; and
providing the code related content to the mobile device, the code related content comprising at least one short code associated with a charitable organization.

14. The method of claim 9, further comprising entering a user of the mobile device into a raffle for a chance to win a prize.

15. The method of claim 9, wherein the code related content is configured as at least one of a SMS message, a MMS message, or web content.

16. The method of claim 9, wherein the code related content comprises a plurality of short codes associated with various charitable organizations.

17. The method of claim 16, wherein the at least one of a SMS or MMS message received from the mobile device is sent upon selection of a user-selectable content associated with a charitable organization.

18. The method of claim 9, wherein the code is at least one of included with or incorporated into a product, product packaging, or store signage.

19. The method of claim 9, wherein the code related content comprises at least one of multimedia content, or a coupon, or a hyperlink to multimedia content related to at least one of the charitable organizations, a parent organization, or a third-party organization, or a hyperlink to an online greeting card application.

20. A mobile device configured to make a charitable donation, the mobile device comprising:
a code reading function configured to:
read a code with the mobile device, the code comprising at least one of a barcode imaged by a camera of the mobile device or a touchcode read by a touchscreen of the mobile device; and
request code related content in response to reading the code; and
a messaging function configured to:
receive code related content from a server, the code related content comprising at least one short code associated with a charitable organization; and
send at least one of a SMS or MMS message using the short code to make a donation to the charitable organization.
